(19) United States
(12) Patent Application Publication
(10) Pub. No.: US 2014/0167927 A1
(43) Pub. Date: Jun. 19, 2014

(54) Automated Wireless Window Control

(71) Applicant: Joseph James Rush, Collegeville, PA (US)

(72) Inventor: Joseph James Rush, Collegeville, PA (US)

(21) Appl. No.: 13/717,376

(22) Filed: Dec. 17, 2012

(51) Int. Cl. G08C 17/02

(52) U.S. Cl. CPC G08C 17/02
USPC 340/12.5

(57) ABSTRACT

A wireless control unit for the remote operation of windows for the housing industry. The control unit is activated through a wireless connection between a radio inside the control unit and a coordinating radio connected to the internet. Both the control radio and the coordinating radio use the wireless Zigbee protocol. Interface for the user is done via a web application that can remotely control the window or connect the window to a home automation system so that the window will open or close at the users preferences, be it due to temperature, humidity, or any other preferences that are written into the application.

### CROSS-REFERENCE TO RELATED APPLICATIONS

Provisional Application No. 61/652,192

Filed: May 26, 2012

### BACKGROUND OF THE INVENTION

1. Field of the Invention

The current invention relates to the field of home automation. This invention is a control system by where double hung or slider windows can now be added to the realm of home automation so that it is possible to control them with an existing home automation system or actuate them remotely from any device that can connect to the internet.

2. Background of the Invention

At the current time there does not seem to be any windows of a double hung or slider nature that can be controlled by any device connected to the internet. This is something that creates a problem for the home automation industry. While we currently have the technology to operate lights, heating and cooling systems and even garage doors, double hung windows have been left out of this home automation boom. There are casement windows that have electronic control systems but the overwhelming percentage of homes in the United States have double hung or slider windows. This invention will give homeowners the opportunity to add windows into the realm of home automation. It will also give homeowners an added piece of mind when after checking the weather on their phone they also use their phone to close their windows in the case of an oncoming storm. Home heating and cooling systems have been remotely controlled for some time now but what good is it to turn on your air conditioning system from a remote location if the windows in your house are open?

The ease of actuating a casement window is as simple as one pane, one motor; whereas in a double hung or slider window you cannot simple open or close a window from either side, it must be done by applying force to both sides of the sash evenly. This is the start of the complexity of this invention because now that you have to apply force to both sides of the sash it means that you either have to drive both sides with one motor or drive the sides individually. Driving the sides individually is the path of this invention and one pitfall that had to be overcome is driving the opposing sides of the sash evenly. This was accomplished by running each actuator with its own pulse width modulation controller. This part of the design ensures that not only can the actuators installed from the manufacturer be calibrated to run evenly; but in the case of an actuator failing, when the replacement actuator is installed the user can now calibrate the new actuator to run at the same speed of the existing one. Another pitfall of adding windows to any home automation system is the additional wiring needed inside the home to attach each window and control them all separately so you are not drawing to much power and overloading the circuits inside your house. This invention accomplishes this with the new technology of wireless communication. Each individual window has its own MAC address and receives all of the communications wirelessly so the only wiring needed to be connected to the window is a standard 120 volt ac line. The problem with overloading the household circuits by having too many windows opening at one time is simply accomplished by programming the automation system to actuate the windows in succession instead of together. Another obstacle to overcome in the design of automated double hung windows is safety; anyone with a cat knows that one of their favorite places to sleep is on the window sill. This control system has an optic sensor that senses any object that is in the path of the bottom sash and will not let the system operate while the sill is blocked.

### BRIEF SUMMARY OF THE INVENTION

This invention will add today's technology to windows giving them the capability to be added to home automation systems or actuated remotely; giving homeowners the ability to close their windows in the event of a severe storm when they have no way of getting home in time.

This invention will also bring some added efficiency to home heating and cooling systems. There are cooling systems that have remote temperature sensors outside of the house that sense whether the temperature outside is cooler than the current temperature inside. Now imagine if those systems had the added capability to remotely open certain window even at different levels to allow the cooler air inside of the house. The same system could also be programmed to close the windows if the outside temperature climbs above a set point. Along with heaters and air conditioners, windows would then become part of the home heating and cooling system allowing for free cooling during the night and the ability to close any windows due to temperature spikes during the day. The biggest summation of this invention is that the operation of double hung windows haven't changed since their inception, it takes the force of a human to open them. This invention will bring windows into the current century where they belong, using technology to make home climate control more efficient.

### BRIEF DESCRIPTION OF THE DRAWINGS

The following drawings are comprised of 2 electrical and 4 mechanical. These drawings are not to scale and should be used solely for the descriptive purpose of this invention. The term control power will be used often in the following descriptions and unless it is otherwise specified it will refer to 12 volt dc that comes from the power supply shown in FIG. 2.

FIG. 1 is page 1 of 2 of the schematics. This includes the linear actuators, the pulse width modulation controllers, the relay board and the manual switch controls.

FIG. 2 is page 2 of 2 of the schematics. This includes the jam rail, the wireless board, the optic sensors, the voltage dividing circuits and the power supply.

FIG. 3 is a view of the complete window assembly with the interior trim removed. As can be seen by this view all of the components in this invention are easily accessible for replacement in case any of the parts fail.

FIG. 4 is an inside view of the window jam showing the placement of the upper and lower linear actuators and the jam rail.

FIG. 5 is a drawing showing that after the trim is installed to the window, the visual appearance is the same of every other double hung window.

### DETAILED DESCRIPTION OF THE DRAWINGS

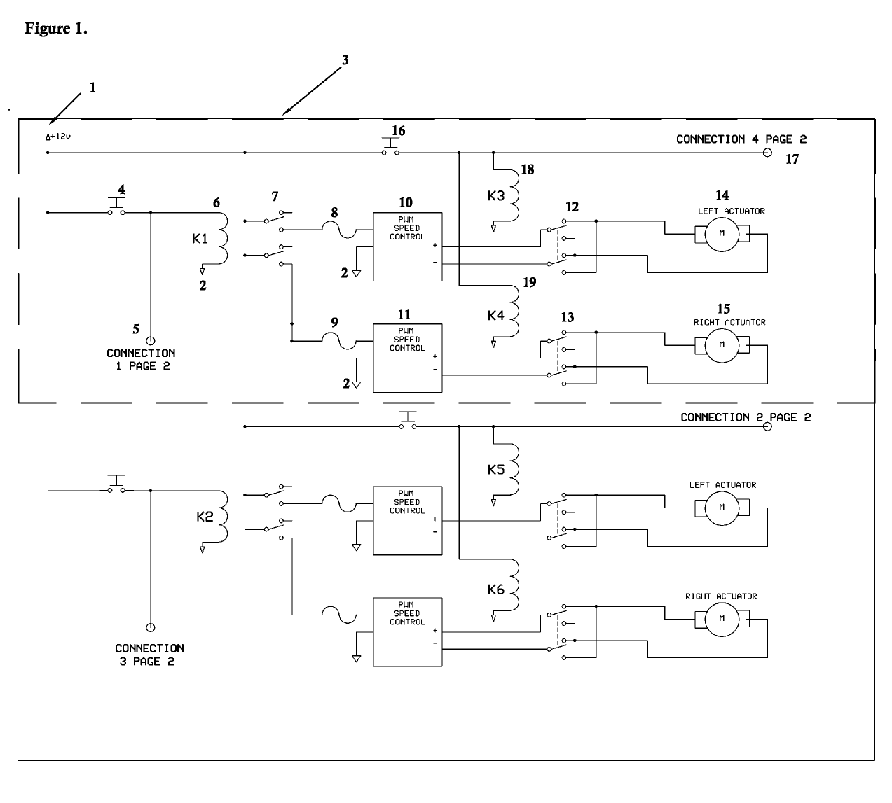

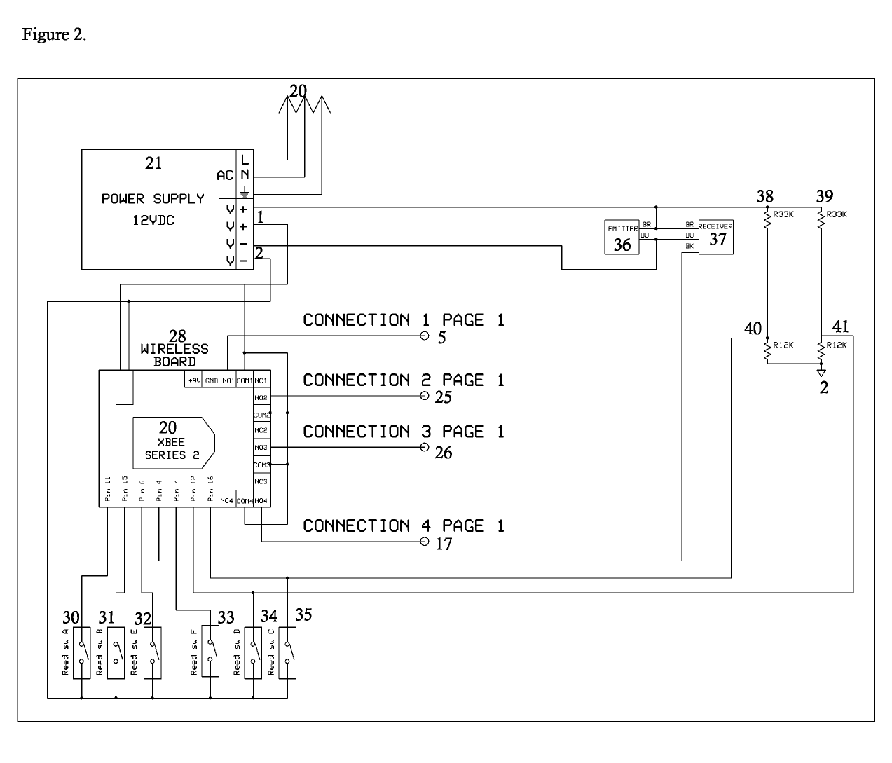

In FIG. 1 the drawing has been broken into two parts comprising of the upper and lower sash controls. The dashed line labeled 3 encompasses the upper sash controls, which will be described in detail below. Since the lower sash controls are identical to the upper sash the following description will go into detail of only the upper sash controls. The 12 volt dc control voltage at 1 is supplied by the power supply 21 in FIG. 2. This 12 volt dc supplies power to switch 4, the commons of relay 7, and switch 16. Both switches 4 and 16 are manual overrides and are used for calibration purposes in the event of replacing either an actuator or a speed controller. When either switch 4 or connection 5 receives control power, connection 5 will be described in detail for FIG. 2, coil 6 is energized which in turn closes relay 7 allowing the control power on the commons of 7 to be sent through fuses 8 and 9 to the pulse width modulation speed controllers 10 and 11. The speed controllers are in the circuit to ensure that the left and right actuators run at the same speed to ensure that the sash opens evenly. After the control power leaves the speed controllers it flows through the commons of relays 12 and 13 and out to the left actuator 14 and the right actuator 15 to open the upper sash unless control power has also been sent to connection 17. If either switch 16 or connection 17, connection 17 will be described in detail in FIG. 2, receives control power then the coils 18 and 19 will be energized switching the relays 12 and 13 which in turn reverses the polarity of the control power going to the left actuator 14 and the right actuator 15 which will then close the upper sash. All commons in the circuit are labeled as 2.

The description of FIG. 2 will start with the 12 volt dc power supply 21. The power specifications will be decided by the amp draw of the linear actuators in the control circuit.

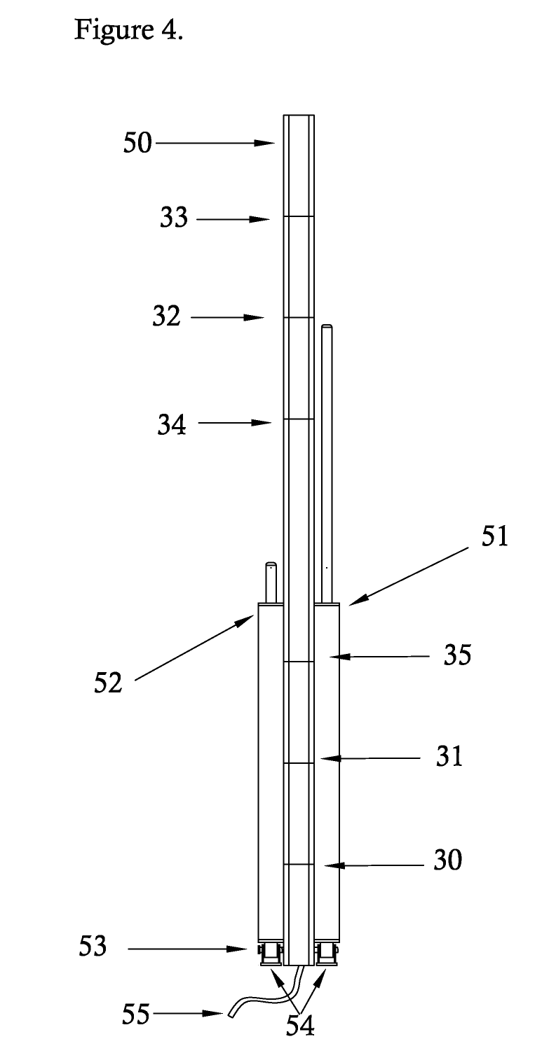

Connection 20 is the 120 volt ac line connecting to the power supply; this will be the only external wiring needed to power this control circuit. The 12 volt dc, also called the control voltage for most of the descriptions, is sent from the terminals at 1 and connected to the wireless board 28 for the dual purpose of energizing the board and the control power for the commons of the relays on this board. The 12 volt dc at terminals 1 is also sent to the optic sensors 36 and 37, the resistors 38 and 39 and also out to +12v label 1 on FIG. 1. The wireless board 28 has a socket that excepts the Xbee Series 2 wireless radio. This board also has 4 single pole relays used for the purpose of sending control power out to the power and switching relays in FIG. 1. It also has seven pin connections to the Xbee board for the purpose of reading the inputs of the optic sensors and the reed switches. The logic can be written in numerous ways assigning different Xbee pin numbers for different functions either inputs or outputs so for the description below only the electrical characteristics of the circuit will be described. When the logic sends the command to toggle any of the output pins of the Xbee radio from low to high it then fires the coil of the relay on the wireless board to which it is wired allowing control voltage to go from the common to the normally closed contact on that relay. In the case of pin 20 of the Xbee radio that in this case is wired to relay 1 of the wireless board, the control power will flow from the common through the normally closed contact out to connection 5. This can then be followed to connection 5 in FIG. 1, which will energize coil 6. All 4 relays on the wireless board 28 work in the manner explained above. The inputs of the wireless board 28 are connected to the reed switches 30 through 35 and the optic sensor receiver 37. These input pins on the wireless board, which could be numbered in any manner, with the exception of pin 12 and 16, are normally set at 3.3 volts dc. The inputs are read at intervals specified by the logic of the program and when actuated by the circuit they will be pulled to 0 volt sending a signal to the Xbee that the corresponding input is active. The two exception pins, both 12 and 16 are normally set to 0 volts so they are set to 3.3 volts by the voltage divider circuits starting at resistors 38 and 39. These resistors along with resistors 40 and 41 make up the two voltage divider circuits needed to set pins 12 and 16 to 3.3 volts dc. Since the voltage divider circuits now set both these pins to 3.3 volts they can be pulled to 0 volts by their corresponding switches and now read as inputs in the same manner as the rest of the switches. The optic sensors 36 and 37 are used to detect if any object is on the sill during the operation of the linear actuators. The logic of the program will monitor this switch before and during operation and if the switch becomes active the logic will stop sending power to the linear actuators. The reed switches 30 through 35 are placed in the jam rail, which will be described in FIG. 4, and are triggered by magnets within the upper and lower sashes to determine positions of the sashes.

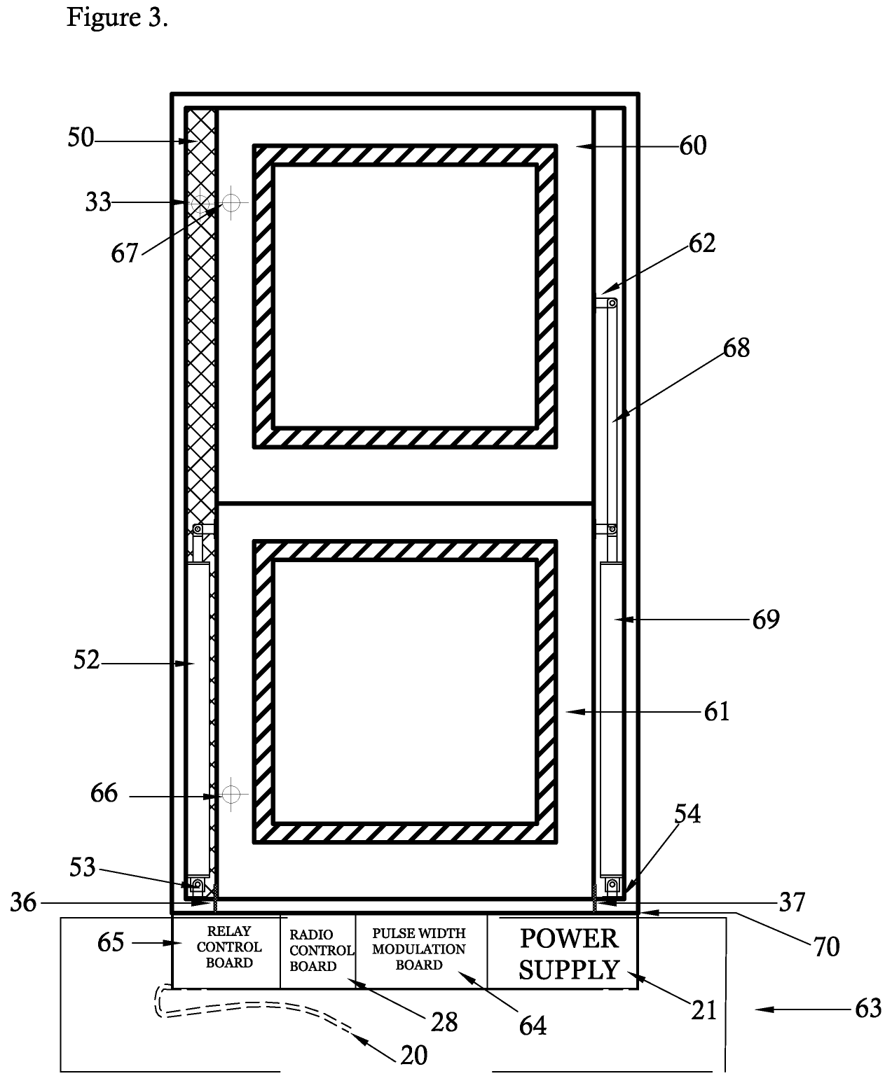

FIG. 3 is a view of the internal parts the window with the interior trim removed. As can be seen by the drawing this would make for easy replacement if any component should need to be replaced. Since most of the internal mechanisms in this window are the same on both the left and right sides; with the exception of the jam rail 50, the sash magnets 33 and 67, and the reed switch 33, labels were only used to point out each item on one side of the window. Label 50 points to a hatched area that is the jam rail. The jam rail 50 will be described in detail in FIG. 4. What can be seen in this drawing is that the jam rail 50 is placed in between the linear actuators on one side of the sashes. Reed switch 33 is shown only as a point within the jam rail 50 since it will be epoxied inside the rail and not visible at all in this invention. What should be noted is that it is in direct line with the upper sash magnet 67 which is also drawn as a point since this as well is epoxied inside the upper sash. The actual position where these two components are placed in the design of this invention is not significant but what is critical is that the upper sash magnet 67 will trigger the upper most reed switch 33 when the upper sash is closed. The upper sash 60 can be designed in any number of ways, the only thing specific to the upper sash for this invention is the addition of the upper sash magnet 67. The upper sash 60 is mounted to the linear actuator 68 by the mounting sash bracket 62. Only the rod on the linear actuator 68 can be seen since the bottom is directly in line with the lower linear actuator 69. This direct alignment of linear actuators allows for the easy removal of both the sashes with just three steps. First remove the through pins 53 on both sides of the window. The lower sash 61 with the linear actuators 52 and 69 attached can now be removed as one unit. Next the jam rail 50 must be disconnected from the control box and removed from the window jam. Now the upper sash 60 with both it's linear actuators attached can now be removed from the window. Note: the jam rail 50 in this invention must be removable from inside the window jam. This can be done in any number of ways and is not specific to this invention. The sill mounting brackets 54 keeps the through pins 53 in place. The optic sensors 36 and 37 are placed inside the jam just above the sill plate in a position such that they will not be triggered by the closing of the window and close enough to the sill plate that no human finger could slide underneath the beam. Since different optic sensors have difference sensing ranges, this description should be sufficient. At the bottom of the window located under the sill plate 70 enclosed within the dashed line is the control box 63. The size of this box is not specific in dimensions but should be the width of the window to facilitate running the wires from the actuators, jam rail and optic sensors down through the sill plate 70 into the control box 63. Since all of the control electronics were described in detail for FIG. 1 and FIG. 2, and the layout of the controls within the box are not design specific; it is only important to state that all of the electronic components within FIGS. 1 and 2 with the exception of the linear actuators and the optic sensors, are all housed within the control box. In the prototype of this invention the electronic controls were mounted to individual circuit boards such as; the relay control board 65, which is comprised of all the power relays and the override switches, the radio control board 28, which houses the Xbee wireless radio and the miniature relays, the pulse width modulation board 64, which houses the speed controllers for the linear actuators, and power supply 21, which converts the ac line voltage to the 12 volt dc control voltage. The layout and design of these circuit boards are not specific and can be designed in any manner as long as it is true to the schematics in FIG. 1 and FIG. 2. The lower sash 61 and its left linear actuator 52 and right linear actuator 69 can be viewed as the complete assembly. In the bottom left hand corner of the lower sash 61 is a point 66 where the lower sash magnet is epoxied inside the sash. Again this exact location is not important but what is specific is that the lower sash magnet must trigger the lowest reed switch in the jam rail 50 when the sash is closed. Since the left lower actuator 52 hides this part of the jam rail 50, a detailed description of the jam rail will be given in FIG. 4.

FIG. 4 is a drawing of the side view of the jam rail and the linear actuators. The jam rail 50 dimensions are not design specific, what is specific is that the jam rail 50 is encased with 6 reed switches, labeled 30 through 35. The exact location of these reed switches is in conjunction with the placement of the sash magnets 66 and 67 shown in FIG. 3. For example: if the lower sash magnet 66 in FIG. 3 is located 5 inches from the bottom of the sash then the corresponding reed switch 30 will also have to be located 5 inches from the bottom of the jam rail 50 so that the reed switch 30 will be triggered when the lower sash is closed. The upper reed switch 33 must have the same placement in conjunction with the upper sash magnet 67 shown in FIG. 3 so that it is also triggered when the sash is closed. The other reed switches can be placed at locations that can only be determined by the design of the window. The inner most reed switches 34 and 35 can be placed in positions either that they would be triggered when the sashes are opened to their full extent or placed so that when both sashes are opened they stop in the exact same location of the window jam leaving equal open spacing at the top and bottom of the sashes. The reed switches 31 and 32 can be placed at locations to be triggered when the sashes are opened midway. The exact location and or placement of these reed switches can change depending on the design of the window, what is specific to this invention is that the reed switches are used to provide a non contact switch to provide location feedback to the control circuit for this invention. The lower actuator 52 is attached to the lower sash in the fully closed position. This part of the design ensures that the lower actuator 52 will stop when the lower sash if fully closed due to the internal switch inside the linear actuator 52. The upper actuator 51 is attached to the upper sash in the fully extended position. This part of the design ensures that the upper actuator 51 can not overdrive the upper sash due to the internal switch in the linear actuator 51. Attaching the linear actuators 52 and 51 in this manner allows for one through pin 53 to attach both linear actuators to the sill plate with their corresponding sill brackets 54. The jam rail 50 must designed to allow for one through pin 53 to attach both lower and upper linear actuators, this can be done in any manner of ways. The jam rail 50 must also be designed so that it is removable from the window jam. This part of the design ensures that in the event of any of the reed switches 30 through 35 failing, a simple replacement of the jam rail 50 will get the window back in operation. Label 55 shows the wire that will be used to connect the jam rail 50 to the control box.

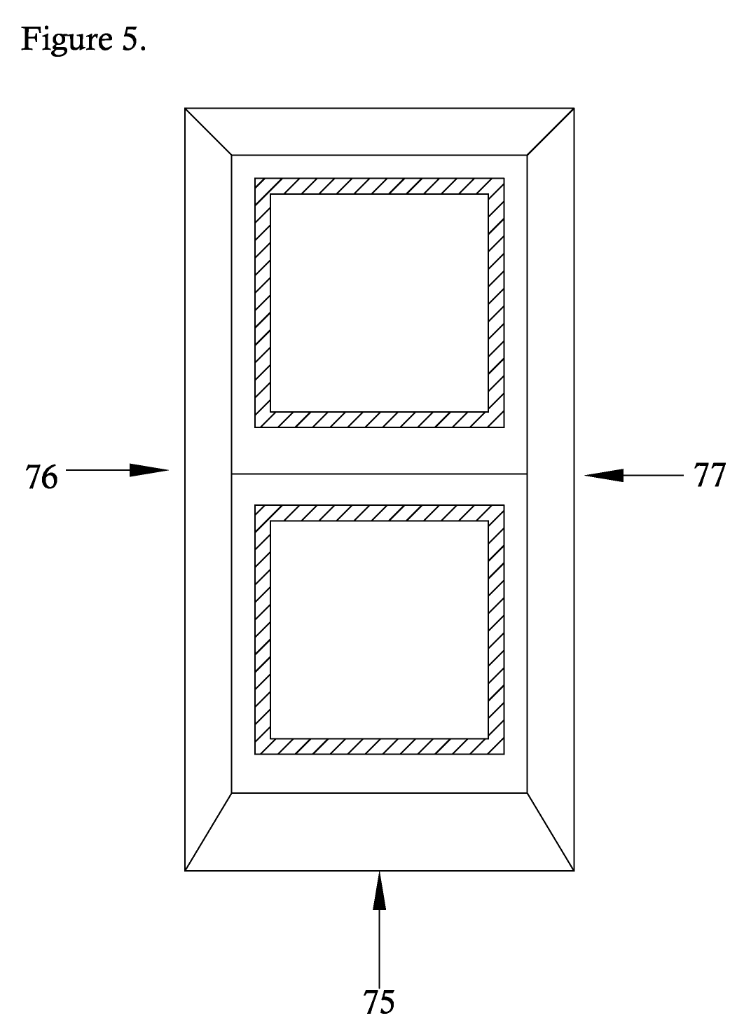

FIG. 5 is a final view how this invention would look from inside a house. As can be seen with the bottom trim 75 extended to cover the control box and the side trims 76 and 77 widened to cover the actuators, this design allows double hung windows to maintain their current look but yet brings double hung windows into the current age of technology.

1. An electronic control system built into the framework of a double hung or sliding window that allows the user to access control of the window from any device that can access the internet. The control system gives the user the flexibility to open the sashes independently to any opening maintaining total control of the window openings just as with a standard double hung or sliding window.

2. The electronic control system in claim 1 is activated using wireless communications that are sent back and forth between the receiving radio inside the control system and a coordinator radio that is connected to the internet.

3. The receiving radio in claim 2 has its own MAC address so the system can be installed into dozens of windows and each one could be accessed independently.

4. The coordinator radio in claim 2 runs internal programs that can be accessed through any number of web-based services. This gives the user flexibility in the way of custom programming and interfacing with the control system through other applications; such as linking up the system to a home automation interface.

5. The wireless communications in claim 2 use Zigbee protocol which gives this invention the capability to be added to any home automation system running Zigbee wireless communications.

6. The electronic control system in claim 1 is assembled from the individual parts consisting of: four linear actuators; one control box; one jam rail and one set of optic sensors.

7. The individual components in claim 6 can be accessed by simply removing the trim on the inside of the window.

8. The optic sensors in claim 6 are used as a safety feature to sense when an object, be it a pet or a child's hand, is on the sill and would be harmed if the window were to close.

9. The jam rail in claim 6 can possess up to 6 reed switches designed as positional sensors for the sashes.

10. The control system in claim 1 can actuate the sashes to the positional sensors in claim 9 or run the linear actuators for a specified period of time to allow for any opening height of the sashes.

11. The linear actuators in claim 6 will be attached to the bottom sill plate with one through pin on each side of the window allowing for easy removal of the actuators in case of failure.

12. The control system in claim 1 will be covered by removable trim from inside the house to facilitate for easy replacement of components.

13. The linear actuators in claim 6 will be controlled by individual speed controllers for the purpose of calibrating the speed of the linear actuators so that the sashes opens evenly.

14. The individual speed controllers in claim 12 will also be used in the calibration procedure in the event of replacing any of the linear actuators.

15. The jam rail in claim 6 will be removable in case of failure to any of the enclosed switches.
